(19) United States
(12) Patent Application Publication
(10) Pub. No.: US 2006/0174777 A1
(43) Pub. Date: Aug. 10, 2006

(54) Staty maker: apparatus for the perpetration of Satay

(76) Inventor: John Paul Roe, Calgary (CA)

Correspondence Address: J. PAUL ROE, 2115 CROCUS RD. N.W., CALGARY, AB, T2L 0Z7, CA

(21) Appl. No.: 11/054,092

(22) Filed: Feb. 10, 2005

(51) Int. Cl. A47J 37/04

(52) U.S. Cl. 99/419

(57) ABSTRACT

A method and apparatus is disclosed for the perpetration of a variety of foods in Satay style. The apparatus comprises two manually positioned platens (upper and lower) and a plurality of food elongated retaining spikes or skewers. The foodstuff is held in the retaining protrusions on the upper and lower platens and spikes or skewering device are pushed into the guiding slots to secure the foodstuff on the spikes or skewers. This unique apparatus can be made of wood, stainless steel, aluminium, carbon fibre, plastic, or any material, which can be worked or machined into the correct configuration, that provide a textured or smooth surface, which can be cleaned and sanitized. The invention provides a quick and safe method of preparing Satay style food.

### REFERENCES CITED (PRIOR ART)

| | | | |
|---|---|---|---|
| Patent | | | |
| number | Filed | Owner | Issued |

U.S. Patent Documents

| | | | |
|---|---|---|---|
| 2,815,530 | Mar. 11, 1955 | Loe E., Alexander | Dec. 10, 1957 |
| 4,583,263 | Oct. 2, 1984 | Wigley, Jr.; Thomas W. | Apr. 22, 1986 |
| 4,429,435 | Jan. 26, 1982 | Walls; James F. | Feb. 7, 1984 |

Canadian Patent Documents

| | | | |
|---|---|---|---|
| CA 2146595 | Apr. 7, 1995 | Khadem, Fereidoun F | Dead |
| | | | Application |

### FIELD OF INVENTION

This invention relates to the preparation for cooking of meat, seafood and fowl, specifically the preparation of Satay style and similar cooking methods for meat, seafood, fowl and an assortment of foodstuffs. This style of barbeque grilling and cooking style is characterized by the use of skewed meat, seafood, fowl, and other foodstuffs, which is then cooked in an oven, on a barbecue pit, in a smoker or other cooker device with condiments and spices. The Satay maker can be made of wood, stainless steel, aluminium, carbon fibre, plastic, or any material, which can be worked or machined into the correct configuration, that provide a surface, which can be cleaned and sanitized.

### BACKGROUND TO THE INVENTION

The preparation of Satay and other foods has been up until now very time consuming and labour intensity. Difficulty is experienced in holding the foodstuff while inserting the spikes or skewers thought the food. Various manual techniques have been employed to hold the foodstuff in place to make a uniform Satay. However, these techniques suffer from the disadvantage of non-uniform food placement on the spikes or skewers. Safety has been an issue, which is address with the Satay Maker. The invention provides unique, fast, and safe apparatus for the preparation of this style food.

### DETAILED DESCRIPTION

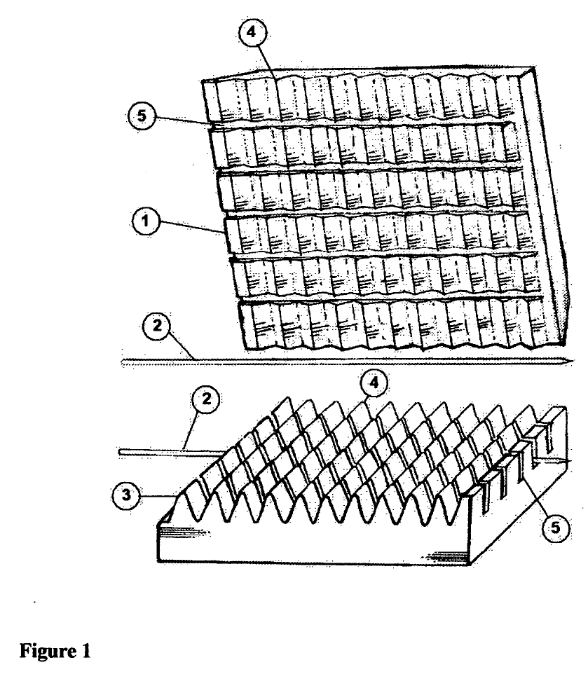

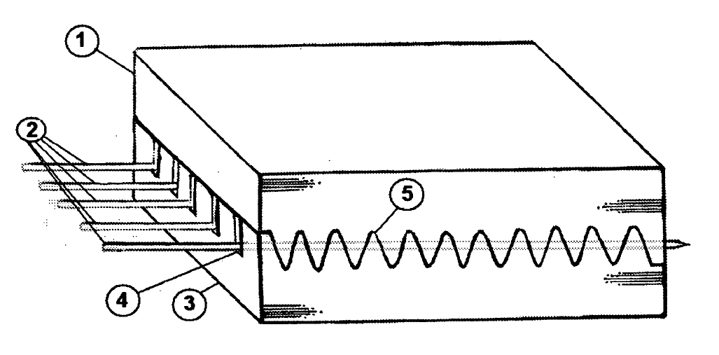

Referring to the drawings, specifically FIGS. 1 and 2,

FIG. 1 is a perspective view of the Satay maker in the open position illustrating the retaining protrusions and showing the spikes or skewers positioned in place and over the guiding slots.

FIG. 2 is a perspective view of the Satay maker in the closed position illustrating the spikes or skewers in position through the guiding slots.

Having described my invention with the particularity set forth, what is claimed is:

1. A satay and food preparation apparatus comprising of an interlocking rigid upper platen, and lower platen. Said upper and lower platens are mirror images with opposing interlock surfaces.

2. The said interlocking upper and lower platens having an array of symmetrically placed rows of food and meat forming and retaining protrusions positioned across the width of both the platens.

3. The said food and meat forming and retaining protrusions are an integral component of the platens.

4. The interlocking upper and lower platens have a plurality of longitudinally parallel spikes or skewers guiding slots extending the length of the upper and lower platens.

5. The said longitudinally parallel spikes or skewers guiding slots having a plurality of spikes or skewers that can be made of a diversity of material types by a variety of methods.

6. The said spikes or skewers are of a length required to match the foodstuff being prepared for satay and long enough to extend through the closed platens as far as is necessary.

7. The said foodstuffs are strategically located on the aforementioned forming and retaining protrusions of lower platen while the satay maker is open. The upper platen is then manually place in position over the lower platen.

8. The said two platens are held in place with hand pressure and the spikes or skewers are pushed through the longitudinally parallel spikes or skewers guiding slots securing the foodstuffs to the completely.

9. The said upper platen is then removed.

10. The said spikes or skewers with the foodstuff in place are removed from the lower platen and taken to a cooking apparatus.
